(19) United States
(12) Patent Application Publication
(10) Pub. No.: US 2008/0231140 A1
(43) Pub. Date: Sep. 25, 2008

(54) ELECTRIC MACHINE HAVING CLAW POLE STATOR

(75) Inventor: Vladimir V. Popov, Villingen (DE)

Correspondence Address: Duane Morris LLP;Suite 1000, 505 9th Street, N.W., Washington, DC, 20004, US

(73) Assignee: Minebea Co., Ltd., Nagano (JP)

(21) Appl. No.: 12/042,946

(22) Filed: Mar. 5, 2008

(30) Foreign Application Priority Data
Mar. 22, 2007 (DE) 10 2007 013 738.0

(51) Int. Cl. H02K 1/12

(52) U.S. Cl. 310/257

(57) ABSTRACT

The present invention relates to an electric machine having a claw pole stator, comprising: a first and a second claw pole plate each of which has a yoke and pole claws, the pole claws connected to the yoke via a base and the claw pole plates being disposed coaxially with respect to one another such that a pole claw rim is formed from the pole claws, the pole claws rim defining a rotor-side boundary of a space for receiving a cylindrical coil, wherein a circular line is defined, whose center coincides with the center of the rotation axis, the circular line intersecting the center point of the baseline of at least one pole claw and having a tangent at this center point, wherein an angle a is formed between this tangent and a straight line connecting the two outer points of the baseline, where α≠0. In an alternative embodiment, the pole claws are twisted with respect to their baselines.

### FIELD OF THE INVENTION

The invention relates to an electric machine having a claw pole stator such as the machine described in US 2002/0005670 A1.

### BACKGROUND OF THE INVENTION

Known claw pole machines comprise a first and a second claw pole plate each of which has a yoke and pole claws, the claw pole plates being disposed coaxially to one another and located opposite each other such that the pole claws face each other and define a space for receiving a coil. A cylindrical coil is disposed coaxially between the opposing claw pole plates and interacts with the pole claws. A rotor is disposed coaxially within the pole claws, so that the pole claws come to lie between the coil and the rotor.

Claw pole machines are suitable for the construction of single-phase permanent magnetic synchronous machines and stepper motors, which can be manufactured easily and at low cost. The claw pole plates may be made of a simple sheet metal material, the pole claws being formed out of the sheet metal material by means of stamping and bending. A pre-fabricated coil may be easily inserted into the space defined by the pole claws.

Single-phase machines have a simple construction and a simple drive system and are frequently designed such that they only operate in one direction of rotation. These kinds of machines are employed, for example, in servo drives, pumps and ventilators, where the transmission of high torques or strong forces is unnecessary and where there are also no particular requirements for precise speed regulation. The relatively low-cost, single-strand machines require no complex winding technique and may be realized by cost-effective commutation electronics consisting, for example, of an H bridge circuit. Furthermore, they may even be operated at AC power supplies without any additional commutation. Instead of a rotating field, a single-phase stator winding generates a pulsating field so that the motor does not generate any torque in certain rotor positions. If the machines are constructed with a single strand, i.e. the stator of the machine is designed with only one winding strand, it is then necessary to take special measures for the start-up of the machine. In two-strand machines, the claw poles and coils are disposed such that the motors can start up without difficulty. It is also known in motors having only a single phase to remove a claw or omit one in order to generate an asymmetric field and thus to guarantee start-up.

Omitting a claw, however, decreases torque and thus distinctly reduces efficiency since there is a claw less for the task of building up torque. Where there is a low overall number of claws (e.g. six), the omission of a claw results in a comparatively high loss of torque. A further disadvantage of this method is that the asymmetry is only required at start-up, whereas efficiency is permanently reduced. In addition, unpleasant noises and vibrations are produced during operation, at least at high rotational speeds, thus limiting the general applicability of this arrangement.

It is an object of the invention to provide an electric machine having a claw pole stator that is designed for single-phase operation, but nevertheless ensures reliable start-up and stable operation in one direction of rotation.

### SUMMARY OF THE INVENTION

The machine according to the invention comprises a first and a second claw pole plate each of which has a yoke and pole claws. The claw poles are connected to the yoke via a base wherein the claw pole plates are arranged axially to each other in such a way that a pole claw rim is formed by the claw poles which defines a rotor-facing boundary of a space for receiving a cylindrical coil. The center point of the baseline of at least one pole claw coincides with a circular line, whose center coincides with the rotor axis. In a first embodiment of the invention, the straight line connecting the two outer points of the baseline and the tangent to the circular line in the center of the baseline form an angle α≠0. In a second embodiment of the invention at least one claw pole is twisted with respect to its baseline. All pole claws of one pole claw plate or of both pole claw plates can be twisted. The oblique arrangement of the pole claws gives rise to reluctance forces between the rotor and the stator due to the magnetic asymmetry, the reluctance forces ensuring start-up of the electric machine in a predetermined direction of rotation and stable running of the machine in this direction of rotation. This oblique arrangement of the pole claws may be provided on one side only, i.e. starting from only one claw pole plate, or on both sides.

The feature that the center point of the baseline of at least one pole claw coincides with a circular line does not mean that the baselines of the pole claws coincide fully with this circular line, but rather that the baselines of the pole claws intersect one and the same circular line, in other words that they are disposed annularly along this circular line, or lie on the circular line. The baselines of the pole claws, however, may also be disposed obliquely to this circular line, or obliquely to a tangent to the circular line. Here, it is not necessary for all the pole claws to have the same angle of obliqueness to this tangent, some pole claws in particular may also be disposed in a straight line, i.e. have an angle of zero degrees to the tangent.

The baselines of the pole claws may either be straight or curved. If the baselines of the pole claws are curved, their radius of curvature preferably corresponds to the radius of the circular line.

In the preferred embodiment of the invention, the claw pole plates are made of a sheet metal material and the pole claws formed out of the sheet metal material by stamping and bending.

As mentioned above, the claw pole machine according to the invention is preferably realized as a single-phase permanent magnetic synchronous machine or as a single-phase stepper motor. To this effect, a cylindrical coil is disposed in the space defined by the pole claws, so that it is disposed coaxially between the claw pole plates and interacts with the pole claws. A cylindrical rotor is coaxially disposed within the pole claws, so that the pole claws come to lie between the coil and the rotor.

### SHORT DESCRIPTION OF DRAWINGS

The invention is described in more detail below on the basis of preferred embodiments with reference to the drawings. The figures show:

FIGS. 1a and 1b schematic perspective exploded views of a claw pole machine according to the prior art seen from the respective opposing end face;

FIG. 2 a schematic exploded view of a claw pole machine according to the invention;

FIGS. 3a and 3b a schematic view from above and a perspective view of a first embodiment of a claw pole plate that can be used in the claw pole machine of FIG. 2;

FIGS. 4a and 4b a schematic view from above and a perspective view of a second embodiment of the claw pole plate that can be used in the claw pole machine of FIG. 2;

FIG. 5 a schematic perspective exploded view of a claw pole machine according to a further embodiment of the invention;

FIGS. 6a and 6b a schematic view from above and a perspective view of an embodiment of the claw pole plate that can be used in the claw pole machine of FIG. 5;

FIGS. 7a and 7b a schematic view from above and a perspective view of an embodiment of the claw pole plate that can be used in the claw pole machine of FIG. 5.

### DETAILED DESCRIPTION

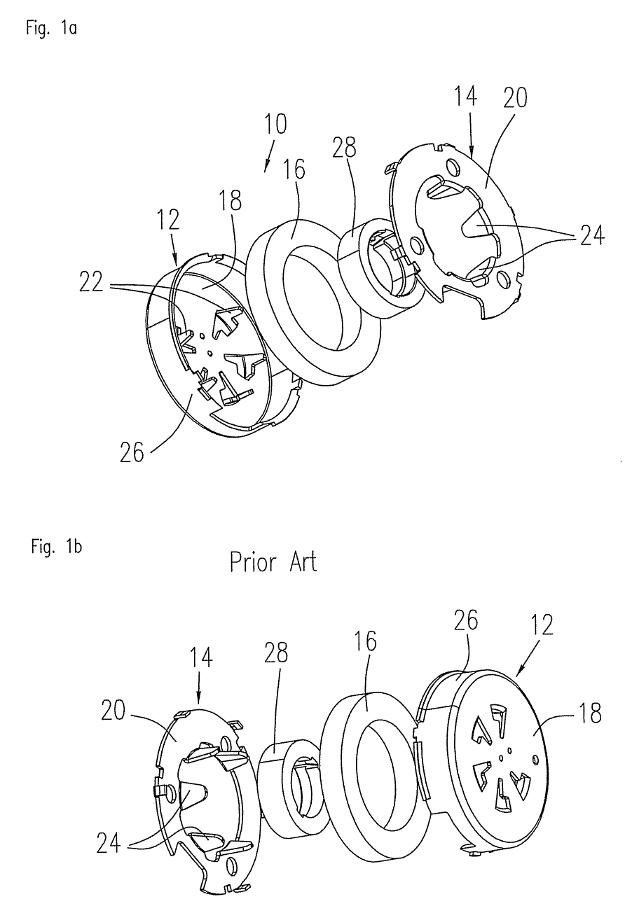

In schematic exploded views, FIGS. 1a and 1b show a claw pole machine according to the prior art, each seen from the opposing end face. In the schematic drawings only the stator and the rotor are shown, further details such as the shaft, electric connections and such like being omitted.

The stator 10 of the claw pole machine of the prior art is made up of two opposing claw pole plates 12, 14, between which a coil 16 is inserted. Each of the claw pole plates comprises a yoke 18 or 20 respectively and a plurality of pole claws 22 or 24 respectively, the claw pole plates 18, 20 being disposed coaxially to one another and being located opposite each other such that the respective pole claws 22, 24 face each other and define a space for receiving the coil 16. Claw pole plate 12 further has a housing wall 26 that encloses the stator and the rotor of the claw pole machine.

In the illustrated embodiment, the rotor 28 is formed by a ring magnet that has, depending on the application, an appropriate number of magnet pole pairs. As an alternative, the rotor may also be made up of a plurality of single magnets. The rotor is disposed coaxially within the pole claws 22, 24, the pole claws coming to lie between the coil 16 and the rotor 28.

In the illustrated embodiment, the claw pole plates 12, 14 are made of a sheet metal material, the pole claws 22, 24 being formed out of the sheet metal material by means of stamping and bending with a claw being omitted in the process. As can be seen from FIGS. 1a and 1b, there are only five claws, the sixth place remaining empty. Moreover, claw poles 22 are stamped out in such a manner that the ends have a lateral recess. This goes to ensure that the machine can start-up from standstill. The pole claws 22, 24 lie on a circular line whose center coincides with the axis of the claw pole machine.

In the single-strand claw pole machine of the prior art, there is the problem that for certain rotor positions, the direction of rotation is undefined at start-up, so that special measures have to be taken to ensure reliable start-up of the machine. Furthermore, these kinds of single-strand machines are frequently used in applications in which the motor should only rotate in one direction, such as in ventilators and pumps. These motors moreover need no special drive, but can be operated directly at the AC power supply. Nevertheless, care must be taken to ensure that the machine always rotates in the right direction.

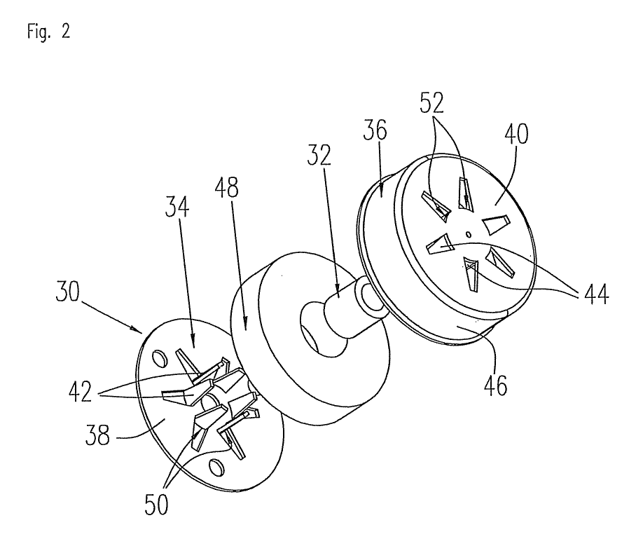

To achieve this, the invention provides a single-strand claw pole machine as illustrated, for example, in FIGS. 2 to 4.

The claw pole machine according to the invention comprises a stator 30 and a rotor 32 that may be basically constructed in the same way as the stator and rotor of the prior art, the design of the pole claws differing from that of the prior art. In the illustrated embodiment, the stator comprises two claw pole plates, of which one takes the form of a stator plate 34 and the other of a stator cap 36. The claw pole plates 34, 36 each comprise a yoke 38, 40 and a plurality of pole claws 42, 44. The stator cap 36 additionally comprises a housing wall 46 that encloses the claw pole machine and, together with the pole claws 42, 44, defines a space for receiving the coil 48.

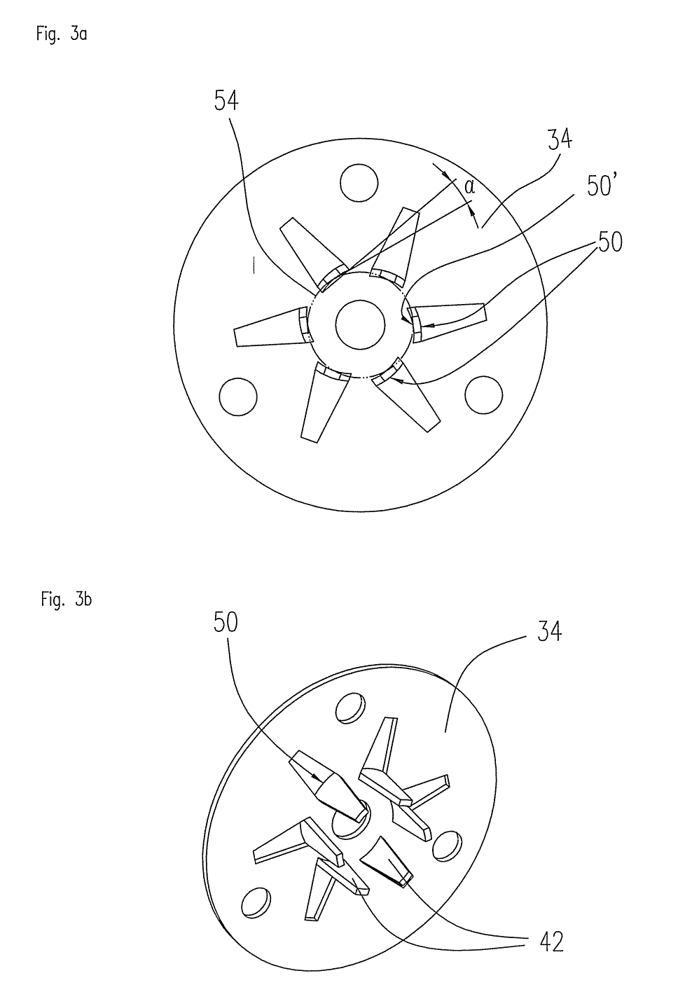

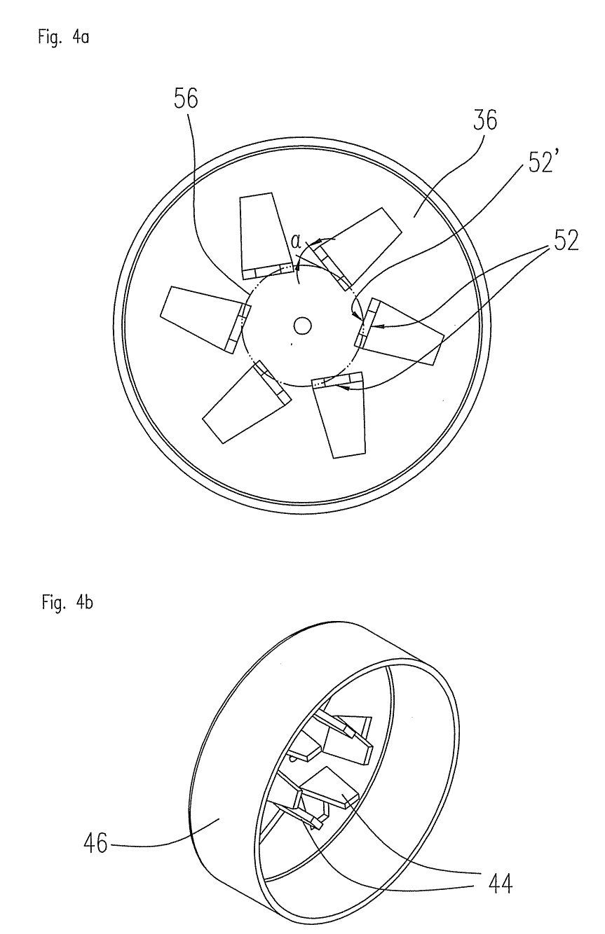

In the illustrated embodiment of the invention, the pole claws 42, 44 are stamped out of the yoke 38, 40 of the associated claw pole plate 34, 36 and bent at their base 50, 52, so that they project at a right angle from the associated yoke 48, 40. Examples for the design of the pole claws 42, 44 according to the invention are described with reference to FIGS. 3a and 3b, 4a and 4b as well as 5, 6a and 6b and 7a and 7b.

FIGS. 3a and 3b show a stator plate 34 having pole claws 42 that are stamped out of the stator plate 34 and bent at their bases 50. As can best be seen from FIG. 3a, the baselines 50′ of the pole claws 42 are disposed obliquely with respect to the tangent to a circular line 54 that runs through the center of the baselines 50′ of pole claws. In the embodiment of FIGS. 3a and 3b, the baselines 50′ of the pole claws 42 are curved, wherein they substantially have the same radius of curvature as the circular line 54, but do not lie exactly on this circular line. The straight line that connects the two outer points of a baseline 50′ is displaced by an angle α vis-à-vis a tangent to this circular line, where 0°<α≦45° A preferred angular range for α can be said to be approximately 5° to 15°.

In another embodiment shown in FIGS. 4a and 4b, the oblique pole claws 44 are formed in the stator cap 36. In this embodiment, the pole claws 44 have straight bases 52 and therefore straight baselines 52′ that are disposed obliquely with respect to a tangent to the circular line 56 intersecting the center point of the baselines 52′. In the embodiment of FIGS. 4a and 4b, the angle α of the baselines 52′ is approximately 8° vis-à-vis a tangent to the circular line 56. The preferred angular range is similar to that of the previous embodiment.

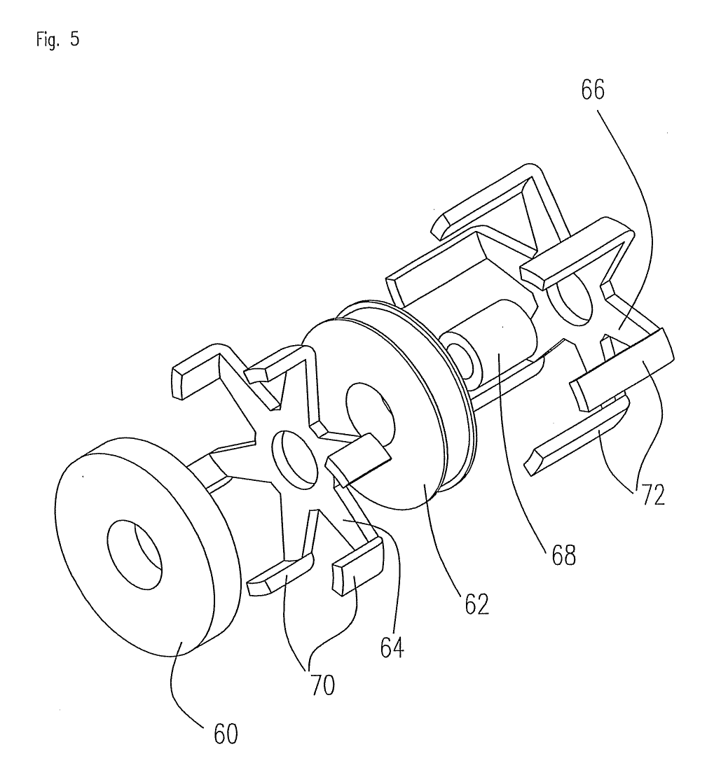

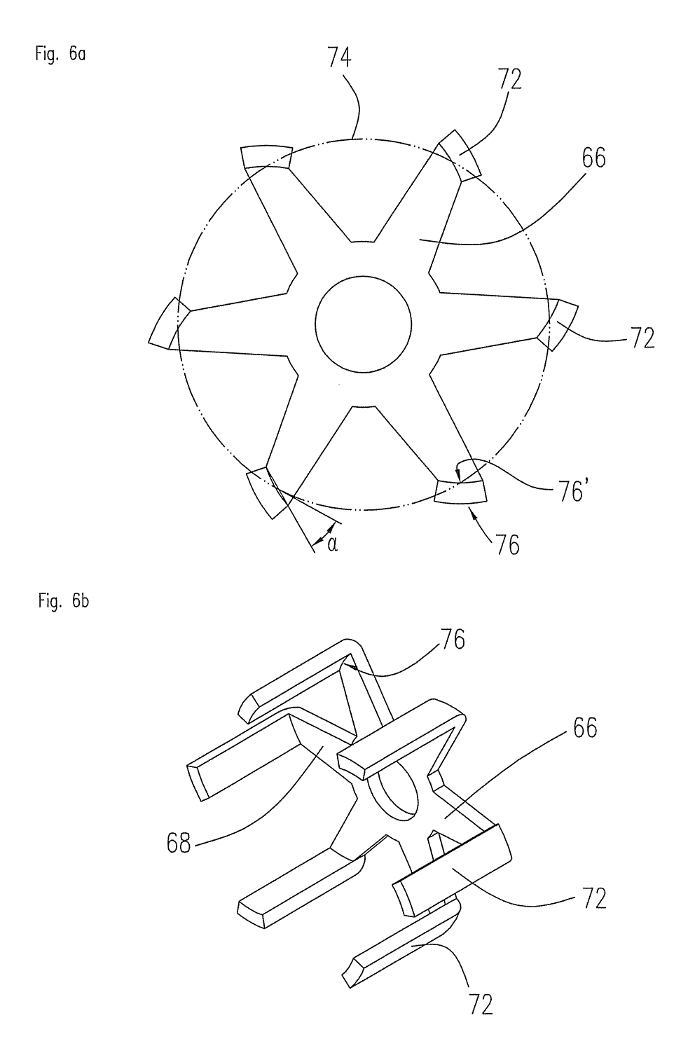

A further embodiment of the claw pole machine according to the invention is described with reference to FIGS. 5, 6a, 6b, 7a and 7b. In the illustrated embodiment, the claw pole machine comprises an annular rotor magnet 60 and a stator coil 62 that are coaxially disposed to two claw pole plates 64, 66. The claw pole plates 64, 66 are connected to each other via a yoke 68 and have the same number of pole claws 70, 72. The pole claws 70, 72 are oriented in the same axial direction, the stator coil 62 coming to lie between the claw pole plates 64 and 66. The pole claws 70, 72, 82 are offset with respect to one another and enclose the stator coil 62 and the rotor magnet 60. As explained in more detail with reference to FIGS. 6a and 6b, the pole claws 70, 72 are displaced vis-à-vis the tangent to the claw pole plates 64, 66, in order to achieve the oblique arrangement according to the invention.

FIGS. 6a and 6b show claw pole plate 66 in a view from above and in a perspective view, claw pole plate 64 being constructed accordingly. The claw pole plates may be stamped out of metal sheet, the pole claws 70, 72 being bent in an axial direction at approximately 90°. As can best be seen in FIG. 6a, the pole claws 72 are bent such that the bases 76 of the pole claws 72 and therefore also the baselines 76′ are disposed obliquely at an angle a with respect to the tangent to a circular line 74 that runs through the center of the baselines 76′. The angle can take on the same values as in the above-described embodiments.

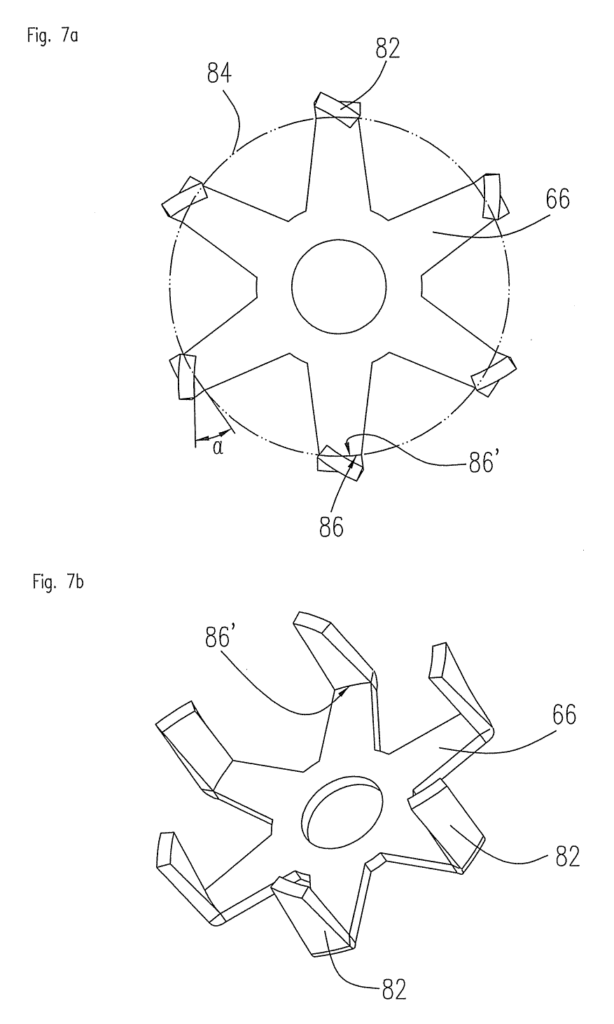

FIGS. 7a and 7b show a pole plate 66 in a view from above and in a perspective view, the claw pole plate 64 being constructed accordingly. The claw pole plates may be stamped out of a metal sheet, the pole claws 82 being bent in an axial direction at approximately 90°. As can be seen in the figures, the pole claws 82 are twisted with respect to their baselines 86′.

Compared to the prior art shown in FIGS. 1a and 1b, both embodiments have the advantage that all the claws are available and can play a part in conducting the magnetic flux, thus achieving both greater torque and higher efficiency as well.

According to the invention, such pole claws that are disposed obliquely can be provided in either the stator plate 34 or the stator cap 36 or in both claw pole plates 34, 36. Depending on the design, the pole claws of the stator plate and/or the stator cap may have curved or straight baselines. It is also within the scope of the invention to provide pole claws whose baselines lie exactly on the circular line 54 or 56, the pole claws themselves then being twisted vis-à-vis the circular line as is shown in FIG. 7.

Arranging the pole claws obliquely makes it possible to provide a single-strand claw pole motor that starts up reliably in a defined direction and shows running stability in operation. The invention makes it possible, particularly if all pole claws are disposed obliquely, to increase efficiency at start-up and in the stable operation of the motor. The claw pole machine according to the invention can be operated as a single-phase permanent magnetic synchronous motor or as a stepper motor.

The characteristics revealed in the above description, the claims and the figures can be important for the realization of the invention in its various embodiments both individually and in any combination whatsoever.

### LIST OF REFERENCE SIGNS

10 Stator
12, 14 Claw pole plates
16 Coil
18, 20 Yoke
22, 24 Pole claws
26 Housing wall
28 Rotor
30 Stator
32 Rotor
34 Claw pole plate, stator plate
36 Claw pole plate, stator cap
38, 40 Yoke
42, 44 Pole claws
46 Housing wall
48 Coil
50, 52 Base
50′; 52′ Baseline
54, 56 Circular line
60 Rotor magnet
62 Stator coil
64, 66 Claw pole plate
68 Yoke
70, 72, 82 Pole claws
74, 84 Circular line
76, 86 Base
76′, 86′ Baseline
82 Pole Claws
□ Angle of obliqueness

We claim:

1. An electric machine having a claw pole stator, comprising: a first and a second claw pole plate each of which has a yoke and pole claws, the pole claws connected to the yoke via a base and the claw pole plates being disposed coaxially with respect to one another such that a pole claw rim is formed from the pole claws, the pole claws rim defining a rotor-side boundary of a space for receiving a cylindrical coil, wherein a circular line is defined, whose center coincides with the center of the rotation axis, the circular line intersecting the center point of the baseline of at least one pole claw and having a tangent at this center point, wherein an angle a is formed between this tangent and a straight line connecting the two outer points of the baseline, where α≠0.

2. An electric machine having a claw pole stator, comprising: a first and a second claw pole plate each of which has a yoke and pole claws, the pole claws connected to the yoke via a base and the claw pole plates being disposed coaxially with respect to one another such that a pole claw rim is formed from the pole claws, the pole claws rim defining a rotor-side boundary of a space for receiving a cylindrical coil, wherein a circular line is defined, whose center coincides with the center of the rotation axis, the circular line intersecting the center point of the baseline of at least one pole claw and having a tangent at this center point, wherein at least one pole claw is twisted with respect to its baseline.

3. A claw pole machine according to claim 1, wherein the baselines of the pole claws are straight or curved.

4. A claw pole machine according to claim 3, wherein the radius of curvature of the curved baselines corresponds to the radius of the circular line.

5. A claw pole machine according to claim 1, wherein the claw pole plates are made of a sheet metal material and the pole claws are formed out of the sheet metal material by means of stamping and bending.

6. A claw pole machine according to claim 1, further comprising a substantially cylindrical rotor that is disposed coaxially within the pole claws, the pole claws coming to lie between the coil and the rotor.

7. A claw pole machine according to claim 1, wherein it is realized as a single-phase permanent magnetic synchronous machine or as a single-phase stepper motor.

8. A claw pole machine according to claim 2, wherein the baselines of the pole claws are straight or curved.

9. A claw pole machine according to claim 8, wherein the radius of curvature of the curved baselines corresponds to the radius of the circular line.

10. A claw pole machine according to claim 2, wherein the claw pole plates are made of a sheet metal material and the pole claws are formed out of the sheet metal material by means of stamping and bending.

11. A claw pole machine according to claim 2, further comprising a substantially cylindrical rotor that is disposed coaxially within the pole claws, the pole claws coming to lie between the coil and the rotor.

12. A claw pole machine according to claim 2, wherein it is realized as a single-phase permanent magnetic synchronous machine or as a single-phase stepper motor.
